(19) United States
(12) Patent Application Publication
(10) Pub. No.: US 2010/0086866 A1
(43) Pub. Date: Apr. 8, 2010

(54) UNDERCOAT LAYERS COMPRISING SILICA MICROSPHERES

(75) Inventors: Francisco J. Lopez, Rochester, NY (US); Man K. Yip, Webster, NY (US); Robert P. Altavela, Webster, NY (US); Adilson P. Ramos, Webster, NY (US)

Correspondence Address: PILLSBURY WINTHROP SHAW PITTMAN, LLP;XEROX CORPORATION, P.O. BOX 10500, MCLEAN, VA, 22102, US

(73) Assignee: XEROX CORPORATION, Norwalk, CT (US)

(21) Appl. No.: 12/247,723

(22) Filed: Oct. 8, 2008

(51) Int. Cl. G03G 15/04; G03G 5/07

(52) U.S. Cl. 430/60; 430/133

(57) ABSTRACT

The presently disclosed embodiments are directed to an improved imaging member exhibiting little or no plywood print defect comprising an undercoat layer formed from an undercoat layer dispersion comprising silica microspheres, a binder resin and a solvent, and a method for making the undercoat layer.

### BACKGROUND

The presently disclosed embodiments relate generally to layers that are useful in imaging apparatus members and components, for use in electrostatographic, including digital, apparatuses. More particularly, the embodiments pertain to undercoat layers that include silica microspheres. The present embodiments provide imaging members which comprise such undercoat layers and consequently suffer reduced or no plywood print defects.

Electrophotographic imaging members, e.g., photoreceptors, photoconductors, imaging members, and the like, can include a photoconductive layer formed on an electrically conductive substrate. The photoconductive layer is an insulator in the substantial absence of light so that electric charges are retained on its surface. Upon exposure to light, charge is generated by the photoactive pigment, and under applied field charge moves through the photoreceptor and the charge is dissipated.

In electrophotography, also known as xerography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. Charge generated by the photoactive pigment move under the force of the applied field. The movement of the charge through the photoreceptor selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

An electrophotographic imaging member may be provided in a number of forms. For example, the imaging member may be a homogeneous layer of a single material such as vitreous selenium or it may be a composite layer containing a photoconductor and another material. In addition, the imaging member may be layered. These layers can be in any order, and sometimes can be combined in a single or mixed layer.

Multilayered photoreceptors or imaging members can have at least two layers, and may include a substrate, a conductive layer, an optional charge blocking layer (sometimes referred to as an “undercoat layer”), an optional adhesive layer, a photogenerating layer (sometimes referred to as a “charge generation layer,” “charge generating layer,” or “charge generator layer”), a charge transport layer, an optional overcoating layer and, in some belt embodiments, an anticurl backing layer. In the multilayer configuration, the active layers of the photoreceptor are the charge generation layer (CGL) and the charge transport layer (CTL). Enhancement of charge transport across these layers provides better photoreceptor performance. Overcoat layers are commonly included to increase mechanical wear and scratch resistance. In conventional photoreceptors, mechanical wear due to cleaning blade contact or scratches due to contact with paper or carrier beads causes photoreceptor devices to fail. As such, overcoat layers are employed to extend the life of the photoreceptor.

Coherent illumination is used in electrophotographic printing for image formation on photoreceptors. Unfortunately, the use of coherent illumination sources in conjunction with multilayered photoreceptors results in a print quality defect known as the “plywood effect” or the “interference fringe effect.” This defect consists of a series of dark and light interference patterns that occur when the coherent light is reflected from the interfaces that pervade multilayered photoreceptors. In organic photoreceptors, primarily the reflection from the air/charge transport layer interface (e.g., top surface) and the reflection from the undercoat layer or charge blocking layer/substrate interface (e.g., substrate surface) account for the interference fringe effect. The effect can be eliminated if the strong charge transport layer surface reflection or the strong substrate surface reflection is eliminated or suppressed.

Methods have been proposed to suppress plywood print defect, including honing the substrate with glass or aluminum oxide beads as light scattering particles. The honing process produces a rough surface on the substrate that provides enough light scatter so as to change the refractive index and remove the plywood print defect in the prints. A problem with conventional undercoat layers employing light scattering particles, however, is that the range of suitable materials for the light scattering particles is somewhat limited. In addition, the honing process is expensive and can itself cause defects in the substrate if not performed properly. Thus, there is a need for an improved undercoat layer which avoids or minimizes the problems discussed above.

Conventional photoreceptors are disclosed in the following patents, a number of which describe the presence of light scattering particles in the undercoat layers: Yu, U.S. Pat. No. 5,660,961; Yu, U.S. Pat. No. 5,215,839; and Katayama et al., U.S. Pat. No. 5,958,638. The term “photoreceptor” or “photoconductor” is generally used interchangeably with the terms “imaging member.” The term “electrostatographic” includes “electrophotographic” and “xerographic.” The terms “charge transport molecule” are generally used interchangeably with the terms “hole transport molecule.”

### SUMMARY

According to aspects illustrated herein, there is provided an imaging member, comprising a substrate, an undercoat layer disposed on the substrate, and an imaging layer disposed on the undercoat layer, wherein the undercoat layer is formed from an undercoat layer dispersion comprising silica microspheres with light scatter sufficient to change a refractive index of the undercoat layer dispersion and substantially eliminate plywood print defect in prints using the imaging member, a binder resin and a solvent.

An embodiment further embodiment provides an imaging member, comprising an aluminum substrate, an undercoat layer disposed on the substrate, and an imaging layer disposed on the undercoat layer, wherein the undercoat layer is formed from an undercoat layer dispersion comprising methylsesquioxane microspheres, titanium oxide, a phenolic binder resin and an organic solvent.

Yet another embodiment, there is provided a method for a method for making an imaging member exhibiting substantially reduced levels of plywood print defect, comprising providing a substrate, dispersing methylsesquioxane microspheres and a binder resin in a solvent to form an undercoat layer dispersion, using the undercoat layer dispersion to form an undercoat layer on the substrate, and forming an imaging layer on the undercoat layer.

### BRIEF DESCRIPTION OF THE DRAWINGS

For a better understanding, reference may be had to the accompanying figure.

FIG. 1 represents a simplified side view of a photoreceptor in accordance with a first embodiment of the present embodiments;

FIG. 2 represents a simplified side view of a photoreceptor in accordance with a second embodiment of the present embodiments;

FIG. 3 represents a graphical comparison of the electrical characteristics of a control photoreceptor and inventive photoreceptor having 32 μm CTL thickness;

FIG. 4 represent a graphical comparison of the charge acceptance curves of a control photoreceptor and inventive photoreceptor having 32 μm CTL thickness; and

FIG. 5 represent a graphical comparison of the differences between the control photoreceptor and inventive photoreceptor having 32 μm CTL thickness.

Unless otherwise noted, the same reference numeral in different Figures refers to the same or similar feature.

### DETAILED DESCRIPTION

In the following description, reference is made to the accompanying drawings, which form a part hereof and which illustrate several embodiments. It is understood that other embodiments may be utilized and structural and operational changes may be made without departure from the scope of the present disclosure. The same reference numerals are used to identify the same structure in different figures unless specified otherwise. The structures in the figures are not drawn according to their relative proportions and the drawings should not be interpreted as limiting the disclosure in size, relative size, or location.

The presently disclosed embodiments are directed generally to providing undercoat layers that incorporate silica microspheres in a manner so as to substantially eliminate the plywood print defect that occur in mirrored drums. The present embodiments further avoid the need to hone the substrate in order to minimize the plywood print defect.

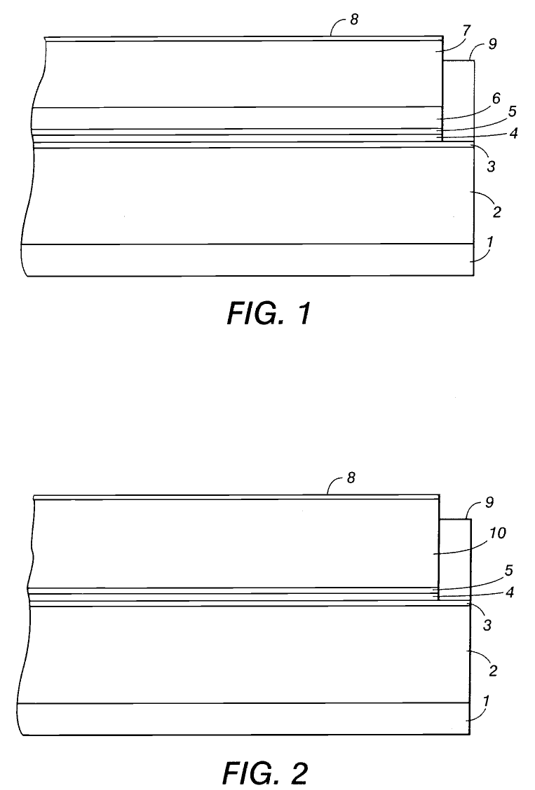

Representative structures of an electrophotographic imaging member (e.g., a photoreceptor) are shown in FIGS. 1-2. These imaging members are provided with an anti-curl layer 1, a supporting substrate 2, an electrically conductive ground plane 3, an undercoat layer 4, an adhesive layer 5, a charge generating layer 6, a charge transport layer 7, an overcoating layer 8, and a ground strip 9. In FIG. 2, imaging layer 10 (containing both charge generating material and charge transport material) takes the place of separate charge generating layer 6 and charge transport layer 7.

As seen in the figures, in fabricating a photoreceptor, a charge generating material (CGM) and a charge transport material (CTM) may be deposited onto the substrate surface either in a laminate type configuration where the CGM and CTM are in different layers (e.g., FIG. 1) or in a single layer configuration where the CGM and CTM are in the same layer (e.g., FIG. 2) along with a binder resin. The photoreceptors embodying the present embodiments can be prepared by applying over the electrically conductive layer the charge generation layer 6 and, optionally, a charge transport layer 7. In embodiments, the charge generation layer and, when present, the charge transport layer, may be applied in either order.

The Anti-Curl Layer

For some applications, an optional anti-curl layer 1 can be provided, which comprises film-forming organic or inorganic polymers that are electrically insulating or slightly semi-conductive. The anti-curl layer provides flatness and/or abrasion resistance. Anti-curl layer 1 can be formed at the back side of the substrate 2, opposite the imaging layers. The anti-curl layer may include, in addition to the film-forming resin, an adhesion promoter polyester additive. Examples of film-forming resins useful as the anti-curl layer include, but are not limited to, polyacrylate, polystyrene, poly(4,4′-isopropylidene diphenylcarbonate), poly(4,4′-cyclohexylidene diphenylcarbonate), mixtures thereof and the like.

Additives may be present in the anti-curl layer in any desired or effective amount, in one embodiment at least about 0.5 weight percent of the anti-curl layer, and in one embodiment no more than about 40 weight percent of the anti-curl layer, although the amount can be outside of these ranges. Suitable additives include organic and inorganic particles which can further improve the wear resistance and/or provide charge relaxation property. Suitable organic particles include Teflon powder, carbon black, and graphite particles. Suitable inorganic particles include insulating and semiconducting metal oxide particles such as silica, zinc oxide, tin oxide and the like. Another semiconducting additive is the oxidized oligomer salts as described in U.S. Pat. No. 5,853,906. The oligomer salts are oxidized N,N,N′,N′-tetra-p-tolyl-4,4′-biphenyldiamine salt.

Adhesion promoters useful as additives include, but are not limited to, duPont 49,000 (duPont), Vitel PE-100, Vitel PE-200, Vitel PE-307 (Goodyear), mixtures thereof and the like. Any desired or effective amount of adhesion promoter can be selected for film-forming resin addition, in one embodiment at least about 1 weight percent adhesion promoter, and in one embodiment no more than about 15 weight percent adhesion promoter, based on the weight of the film-forming resin, although the amount can be outside of these ranges. The thickness of the anti-curl layer in one embodiment is at least about 3 micrometers, and in one embodiment no more than about 35 micrometers, and in more specific embodiments about 14 micrometers, although thicknesses outside these ranges can be used.

The anti-curl coating can be applied as a solution prepared by dissolving the film-forming resin and the adhesion promoter in a solvent such as methylene chloride. The solution may be applied to the rear surface of the supporting substrate (the side opposite the imaging layers) of the photoreceptor device, for example, by web coating or by other methods known in the art. Coating of the overcoat layer and the anti-curl layer can be accomplished simultaneously by web coating onto a multilayer photoreceptor comprising a charge transport layer, charge generation layer, adhesive layer, undercoat layer, ground plane and substrate. The wet film coating is then dried to produce the anti-curl layer 1.

The Supporting Substrate

As indicated above, the photoreceptors are prepared by first providing a substrate 2, e.g., a support. The substrate can be opaque or substantially transparent and can comprise any of numerous suitable materials having given required mechanical properties. The substrate can comprise a layer of electrically non-conductive material or a layer of electrically conductive material, such as an inorganic or organic composition. If a non-conductive material is employed, it is necessary to provide an electrically conductive ground plane over such non-conductive material. If a conductive material is used as the substrate, a separate ground plane layer may not be necessary.

The substrate can be flexible or rigid and can have any of a number of different configurations, such as, for example, a sheet, a scroll, an endless flexible belt, a web, a cylinder, and the like. The photoreceptor may be coated on a rigid, opaque, conducting substrate, such as an aluminum drum.

Various resins can be used as electrically non-conducting materials, including, but not limited to, polyesters, polycarbonates, polyamides, polyurethanes, and the like. Such a substrate can comprise a commercially available biaxially oriented polyester known as MYLAR™, available from E. I. duPont de Nemours & Co., MELINEX™, available from ICI Americas Inc., or HOSTAPHAN™, available from American Hoechst Corporation. Other materials of which the substrate may be comprised include polymeric materials, such as polyvinyl fluoride, available as TEDLAR™ from E. I. duPont de Nemours & Co., polyethylene and polypropylene, available as MARLEX™ from Phillips Petroleum Company, polyphenylene sulfide, RYTON™ available from Phillips Petroleum Company, and polyimides, available as KAPTON™ from E. I. duPont de Nemours & Co. The photoreceptor can also be coated on an insulating plastic drum, provided a conducting ground plane has previously been coated on its surface, as described above. Such substrates can either be seamed or seamless.

When a conductive substrate is employed, any suitable conductive material can be used. For example, the conductive material can include, but is not limited to, metal flakes, powders or fibers, such as aluminum, titanium, nickel, chromium, brass, gold, stainless steel, carbon black, graphite, or the like, in a binder resin including metal oxides, sulfides, silicides, quaternary ammonium salt compositions, conductive polymers such as polyacetylene or its pyrolysis and molecular doped products, charge transfer complexes, and polyphenyl silane and molecular (loped products from polyphenyl silane. A conducting plastic drum can be used, as well as a conducting metal drum made from a material such as aluminum.

The thickness of the substrate depends on numerous factors, including the required mechanical performance and economic considerations. The thickness of the substrate is in one embodiment at least about 65 micrometers, and in another embodiment at least about 75 micrometers, and in one embodiment no more than about 150 micrometers, and in another embodiment no more than about 125 micrometers for optimum flexibility and minimum induced surface bending stress when cycled around small diameter rollers, e.g., 19 mm diameter rollers, although the thickness can be outside of these ranges. The substrate for a flexible belt can be of substantial thickness, for example, over 200 micrometers, or of minimum thickness, for example, less than 50 micrometers, provided there are no adverse effects on the final photoconductive device. Where a drum is used, the thickness should be sufficient to provide the necessary rigidity. This is in specific embodiments at least about 1 mm and no more than about 6 mm, although the thickness can be outside of these ranges.

The surface of the substrate to which a layer is to be applied is often cleaned to promote greater adhesion of such a layer. Cleaning can be effected, for example, by exposing the surface of the substrate layer to plasma discharge, ion bombardment, and the like. Other methods, such as solvent cleaning, can be used.

Regardless of any technique employed to form a metal layer, a thin layer of metal oxide generally forms on the outer surface of most metals upon exposure to air. Thus, when other layers overlying the metal layer are characterized as “contiguous” layers, it is intended that these overlying contiguous layers may, in fact, contact a thin metal oxide layer that has formed on the outer surface of the oxidizable metal layer.

The Electrically Conductive Ground Plane

As stated above, photoreceptors prepared in accordance with the present embodiments comprise a substrate that is either electrically conductive or electrically non-conductive. When a non-conductive substrate is employed, an electrically conductive ground plane 3 is employed, and the ground plane acts as the conductive layer. When a conductive substrate is employed, the substrate can act as the conductive layer, although a conductive ground plane may also be provided.

If an electrically conductive ground plane is used, it is positioned over the substrate. Suitable materials for the electrically conductive ground plane include, but are not limited to, aluminum, zirconium, niobium, tantalum, vanadium, hafnium, titanium, nickel, stainless steel, chromium, tungsten, molybdenum, copper, and the like, and mixtures and alloys thereof.

The ground plane can be applied by known coating techniques, such as solution coating, vapor deposition, and sputtering. One method of applying an electrically conductive ground plane is by vacuum deposition. Other suitable methods can also be used.

Thicknesses of the ground plane are within a substantially wide range, depending on the optical transparency and flexibility desired for the electrophotoconductive member. Accordingly, for a flexible photoresponsive imaging device, the thickness of the conductive layer is in one embodiment at least about 20 Angstroms, and in another embodiment at least about 50 Angstroms, and in one embodiment no more than about 750 angstroms, and in another embodiment no more than about 200 angstroms, although the thickness can be outside of these ranges, for an optimum combination of electrical conductivity, flexibility, and light transmission. However, the ground plane can, if desired, be opaque.

The Undercoat Layer

After deposition of any electrically conductive ground plane layer, an undercoat layer 4 can be applied thereto. Electron blocking layers for positively charged photoreceptors permit holes from the imaging surface of the photoreceptor to migrate toward the conductive layer. For negatively charged photoreceptors, any suitable hole blocking layer capable of forming a barrier to prevent hole injection from the conductive layer to the opposite photoconductive layer can be utilized. A blocking or undercoat layer is often positioned over the electrically conductive layer. The term “over,” as used herein in connection with many different types of layers, should be understood as not being limited to instances wherein the layers are contiguous. Rather, the term refers to relative placement of the layers and encompasses the inclusion of unspecified intermediate layers.

As mentioned, photoreceptor devices with undercoat layers that do not provide enough of a difference in the refractive index of their components produce a plywood print defect. The present embodiments add silica microspheres to a dispersion to form the undercoat layer 4, which eliminates plywood print defect without the need to hone the substrate. Silicone resin particles which can be used include those containing molecular network structures of siloxane groups, such as siloxane-bonded alkyl groups, for example. One particular type of silicone resin particle which contains siloxane bonds and silicone groups bonded to methyl groups is those of the TOSPEARL™ series silicone particles. For example, in a particular embodiment, TOSPEARL™145 (available from GE Toshiba Silicones Co., Ltd., Tokyo, Japan), comprising methylsesquioxane spheres, are incorporated into the dispersion. The methylsesquioxane spheres provide ample light scattering properties with a lower effect on the electrical properties of the photoreceptor than previously disclosed light scattering particles. In addition, methylsesquioxane spheres can be added at lower concentrations than previously disclosed light scattering particles and continue to provide the necessary light scattering properties. When properly dispersed in the undercoat dispersion, the light scattering microspheres have a large enough difference in refractive index to the coating dispersion to eliminate plywood print defects in a photoreceptor device coated on a mirror lathed (most reflective) aluminum substrate. In addition to the plywood suppression, such an embodiment has minimal adverse effects on the electrical characteristics of the photoreceptor device when compared to a standard device not including the methylsesquioxane spheres.

The size of the light scattering particles affects the effectiveness of light scattering. The light scattering particles in a specific embodiment have a number average particle size larger than half of the exposure wavelength, but smaller than the thickness of the dried undercoat layer to avoid particle protrusion. The methylsesquioxane spheres have a particle size of in one embodiment at least about 1.0 μm, and in another embodiment at least about 3.0 μm in diameter. In another embodiment methylsesquioxane spheres have a particle size of no more than about 5.0 μm, and in another embodiment no more than about 7.0 μm in diameter, although the particle size can be outside of any of these ranges. In one embodiment, the methylsesquioxane spheres have a particle size of about 4 μm in diameter. The average particle size of 4 μm was confirmed via electron microscope imaging. The imaged sample contained a minimum of 3.85 μm and a maximum of 4.10 μm with an average of 4.0 μm.

Experimentation has shown that the simple addition of silica microspheres, such as TOSPEARL™ 145, may provide enough of a change in refractive index to suppress the plywood print defect without adversely affecting the electrical characteristics of the photoreceptor device. Not only is this a simple step that can be added to the end of the mixing process for any undercoat, but it is very inexpensive compared to honing substrates. The entire process of preparing the TOSPEARL™ and adding it to the undercoat layer might in some embodiments take no more than an hour in a manufacturing setting. In terms of material cost alone, the addition of TOSPEARL™ 145 might be about 1 to 2 cents per drum, compared to about 19 to 50 cents per drum for honing, thus making it very cost effective.

If desired, the light scattering particles can be subjected to a surface treatment process, with a surface treatment material of either a silane coupling agent, a titanate coupling agent, a zirconate coupling agent, or a polymer such as a polyalkylsiloxane like polydimethylsiloxane, which may suppress any hydrophilic properties and may promote hydrophobic or organophilic properties as well as possibly enhancing physical/chemical interactions of the light scattering particles with the binder. The surface treatment process may for instance enhance dispersion stability of the light scattering particles in the undercoat layer dispersion containing the binder, the light scattering particles, the solvent and optionally other ingredients commonly found in the undercoat layer.

Types of the surface treatment material include silane coupling agents such as an alkoxysilane compound; silation agents containing an atom such as halogen, nitrogen, sulfur and the like, combined with silicon; titanate coupling agents; aluminum coupling agents and the like. Examples of the coupling agents with an unsaturated bond include the following compounds such as allyltrimethoxysilane, allyltriethoxysilane, 3-(1-aminopropoxy)-3,3-dimethyl-1-propenyltrimethoxysilane, (3-acryloxypropyl)trimethoxysilane, (3-acryoxypropyl)methyl dimethoxysilane, (3-acyloxypropyl)dimethyl methoxysilane, N-3-(acryloxy-2-hydroxypropyl)-3-aminopropyl triethoxysilane, 3-butenyltriethoxysilane, 2-(chloromethyl)allyltrimethoxysilane, 1,3-divinyltetramethyldisilazane, methacryloxypropyltrimethoxysilane, vinyltrimethoxysilane, vinyltriethoxysilane, O-(vinyloxyethyl)-N-(triethoxysilylpropyl)urethane, allyldimethylchlorosilane, allylmethyldichlorosilane, allyldichlorosilane, allyldimethoxysilane, butenylmethyldichlorosilane and the like.

Suitable materials for the binder include polymers such as polyvinyl butyral, epoxy resins, polyesters, phenolic resins, polysiloxanes, polyamides, polyurethanes, and the like; nitrogen-containing siloxanes or nitrogen-containing titanium compounds, such as trimethoxysilyl propyl ethylene diamine, N-beta(aminoethyl)gamma-aminopropyl trimethoxy silane, isopropyl 4-aminobenzene sulfonyl titanate, di(dodecylbenezene sulfonyl)titanate, isopropyl di(4-aminobenzoyl)isostearoyl titanate, isopropyl tri(N-ethyl amino)titanate, isopropyl trianthranil titanate, isopropyl tri(N,N-dimethyl-ethyl amino)titanate, titanium-4-amino benzene sulfonate oxyacetate, titanium 4-aminobenzoate isostearate oxyacetate, gamma-aminobutyl methyl dimethoxy silane, gamma-aminopropyl methyl dimethoxy silane, and gamma-aminopropyl trimethoxy silane, as disclosed in U.S. Pat. Nos. 4,333,387, 4,286,033, and 4,291,110. The binder may be linear phenolic binder compositions including DURITE® P97 and DURITE® ESD-556C (both available from Borden Chemical) and a non-linear phenolic binder composition, VARCUM® 29108 (available from OxyChem). The binder may be present in an amount ranging from about 10% to about 80% by weight based on the weight of the dried undercoat layer.

The undercoat layer may optionally contain other ingredients including for example electron transporting materials such as diphenoquinones and n-type particles like titanium dioxide, and undercoat materials such as polyvinyl pyridine. These optional ingredients may be present in an amount ranging for example from 0 to about 80% by weight based on the weight of the undercoat layer.

The undercoat layer 4 should be continuous and has a thickness in one embodiment of at least about 0.01 micrometer, and in another embodiment of at least about 0.05 micrometer, and one embodiment of no more than about 10 micrometers, and in another embodiment no more than about 5 micrometers, although the thickness can be outside of these ranges

The undercoat layer 4 can be applied by any suitable technique, such as spraying, dip coating, draw bar coating, gravure coating, silk screening, air knife coating, reverse roll coating, vacuum deposition, chemical treatment, and the like. For convenience in obtaining thin layers, the undercoat layer can be applied in the form of a dilute solution, with the solvent being removed after deposition of the coating by conventional techniques, such as by vacuum, heating, and the like. Generally, a weight ratio of undercoat layer material and solvent of between about 0.5:100 to about 30:100 is satisfactory for spray and dip coating.

The present embodiments further provide a method for forming the electrophotographic photoreceptor, in which the undercoat layer is formed by using a coating solution containing the light scattering particles, the binder resin and a solvent.

The solvent may be an organic solvent which can be a mixture of an azeotropic mixture of C₁-3 lower alcohol and another organic solvent selected from the group consisting of dichloromethane, chloroform, 1,2-dichloroethane, 1,2-dichloropropane, toluene and tetrahydrofuran. The azeotropic mixture mentioned above is a mixture solution in which a composition of the liquid phase and a composition of the vapor phase are coincided with each other at a certain pressure to give a mixture having a constant boiling point. For example, a mixture containing 35 parts by weight of methanol and 65 parts by weight of 1,2-dichloroethane is an azeotropic solution. The azeotropic composition leads to uniform evaporation, thereby forming an uniform undercoat layer without coating defects and improving storage stability of the undercoat coating solution.

The solvent may be a xylene and organic solvent mixture in a weight ratio ranging from about 80(xylene)/20(organic solvent) to about 20/80. The organic solvent may be an alcohol which is in one embodiment a low alcohol solvent (that is, having from one to five carbon atoms) such as methanol, ethanol, butanol, or mixtures thereof. A mixture of xylene and a hydrocarbon organic solvent, such as toluene, can also be used.

The undercoat layer is formed by dispersing the binder resin and the light scattering particles in the solvent to form a coating solution for the undercoat layer; coating the conductive support with the coating solution and drying it. The solvent is selected for improving dispersion in the solvent and for preventing the coating solution from gelation with the elapse of time. Further, the solvent may be used for preventing the composition of the coating solution from being changed as time passes, whereby storage stability of the coating solution can be improved and the coating solution can be reproduced.

The solids content (e.g., all solids such as the binder and microspheres) of the undercoat dispersion is in one embodiment at least about 2%, and in one embodiment no more than about 50% by weight, based on the weight of the dispersion, although the solids content can be outside of these ranges. The solvent, or a mixture of two or more solvents, present in an amount in one embodiment of at least about 50%, and in one embodiment of no more than about 98% by weight, based on the weight of the undercoat dispersion, although the amount can be outside of these ranges.

Suitable weight ratios of the components include the following: microspheres to binder ratio ranging for example from about 1 (microspheres)/40 (binder) to about 1 (microspheres)/4 (binder), in one specific embodiment from about 4.125/40 to about 8.250/40.

The Adhesive Layer

An intermediate layer 5 between the undercoat layer and the charge generating layer may, if desired, be provided to promote adhesion. However, in the present embodiments, a dip coated aluminum drum may be utilized without an adhesive layer.

Additionally, adhesive layers can be provided, if necessary between any of the layers in the photoreceptors to ensure adhesion of any adjacent layers. Alternatively, or in addition, adhesive material can be incorporated into one or both of the respective layers to be adhered. Such optional adhesive layers can have thicknesses of at least 0.001 micrometer in one embodiment, and in another embodiment, no more than about 0.2 micrometer, although the thicknesses can also be outside of these ranges. Such an adhesive layer can be applied, for example, by dissolving adhesive material in an appropriate solvent, applying by hand, spraying, dip coating, draw bar coating, gravure coating, silk screening, air knife coating, vacuum deposition, chemical treatment, roll coating, wire wound rod coating, and the like, and drying to remove the solvent. Suitable adhesives include, for example, film-forming polymers, such as polyester, dupont 49,000 (available from E. I. duPont de Nemours & Co.), Vitel PE-100 (available from Goodyear Tire and Rubber Co.), polyvinyl butyral, polyvinyl pyrrolidone, polyurethane, polymethyl methacrylate, and the like. The adhesive layer may comprise a polyester with a M_{w} of at least 50,000 in one embodiment, or no more than about 100,000 in another embodiment, although the amount can be outside of these ranges. In further embodiments, the polyester has a M_{w} of about 70,000, and a Mₙ of about 35,000.

The Imaging Layer(s)

The imaging layer refers to a layer or layers containing charge generating material, charge transport material, or both the charge generating material and the charge transport material. Either a n-type or a p-type charge generating material can be employed in the present photoreceptor.

The phrase “n-type” refers to materials which predominately transport electrons. Examples of n-type materials include dibromoanthanthrone, benzimidazole perylene, zinc oxide, titanium dioxide, azo compounds such as chlorodiane Blue and bisazo pigments, substituted 2,4-dibromotriazines, polynuclear aromatic quinones, zinc sulfide, and the like.

The phrase “p-type” refers to materials which transport holes. Examples of p-type organic pigments include, for example, metal-free phthalocyanine, titanyl phthalocyanine, gallium phthalocyanine, hydroxy gallium phthalocyanine, chlorogallium phthalocyanine, copper phthalocyanine, and the like.

Illustrative organic photoconductive charge generating materials include azo pigments such as Sudan Red, Dian Blue, Janus Green B, and the like; quinone pigments such as Algol Yellow, Pyrene Quinone, Indanthrene Brilliant Violet RRP, and the like; quinocyanine pigments; perylene pigments such as benzimidazole perylene; indigo pigments such as indigo, thioindigo, and the like; bisbenzoimidazole pigments such as Indofast Orange, and the like; phthalocyanine pigments such as copper phthalocyanine, aluminochloro-phthalocyanine, hydroxygallium phthalocyanine, and the like; quinacridone pigments; or azulene compounds. Suitable inorganic photoconductive charge generating materials include for example cadium sulfide, cadmium sulfoselenide, cadmium selenide, crystalline and amorphous selenium, lead oxide and other chalcogenides. Alloys of selenium are encompassed by embodiments of the instant embodiments and include for instance selenium-arsenic, selenium-tellurium-arsenic, and selenium-tellurium.

Any suitable inactive resin binder material may be employed in the charge generating layer. Examples of organic resinous binders include polycarbonates, acrylate polymers, methacrylate polymers, vinyl polymers, cellulose polymers, polyesters, polysiloxanes, polyamides, polyurethanes, epoxies, polyvinylacetals, and the like.

To create a dispersion useful as a coating composition, a solvent is used with the charge generating material. The solvent can be for example cyclohexanone, methyl ethyl ketone, tetrahydrofuran, alkyl acetate, and mixtures thereof. The alkyl acetate (such as butyl acetate and amyl acetate) can have from 3 to 5 carbon atoms in the alkyl group. The amount of solvent in the composition ranges for example at least 70% by weight, based on the weight of the composition. In one embodiment, the amount is no more than about 98% by weight, based on the weight of the composition, although the amount can be outside of these ranges.

The amount of the charge generating material in the composition ranges for example at least 0.5% by weight, based on the weight of the composition including a solvent. In another embodiment, the amount is no more than 30% by weight, based on the weight of the composition including a solvent, although the amount can be outside of these ranges. The amount of photoconductive particles (i.e., the charge generating material) dispersed in a dried photoconductive coating varies to some extent with the specific photoconductive pigment particles selected. For example, when phthalocyanine organic pigments such as titanyl phthalocyanine and metal-free phthalocyanine are utilized, satisfactory results are achieved when the dried photoconductive coating comprises between about 30 percent by weight and about 90 percent by weight of all phthalocyanine pigments based on the total weight of the dried photoconductive coating. Since the photoconductive characteristics are affected by the relative amount of pigment per square centimeter coated, a lower pigment loading may be utilized if the dried photoconductive coating layer is thicker. Conversely, higher pigment loadings are desirable where the dried photoconductive layer is to be thinner.

Generally, satisfactory results are achieved with an average photoconductive particle size of less than about 0.6 micrometer when the photoconductive coating is applied by dip coating. In a more specific embodiment, the average photoconductive particle size is less than about 0.4 micrometer. In one embodiment, the photoconductive particle size is also less than the thickness of the dried photoconductive coating in which it is dispersed, although the thicknesses can also be outside of these ranges.

In a charge generating layer, the weight ratio of the charge generating material (“CGM”) to the binder ranges from 30 (CGM):70 (binder) to 70 (CGM):30 (binder), although the amount can be outside of these ranges.

For multilayered photoreceptors comprising a charge generating layer (also referred herein as a photoconductive layer) and a charge transport layer, satisfactory results may be achieved with a dried photoconductive layer coating thickness of between about 0.1 micrometer and about 10 micrometers. In one embodiment, the photoconductive layer thickness is at least 0.2 micrometer, and in another embodiment, no more than 4 micrometers, although the thicknesses can also be outside of these ranges. However, these thicknesses also depend upon the pigment loading. Thus, higher pigment loadings permit the use of thinner photoconductive coatings. Thicknesses outside these ranges can be selected providing the objectives of the present embodiments are achieved.

Any suitable technique may be utilized to disperse the photoconductive particles in the binder and solvent of the coating composition. Examples of dispersion techniques include, for example, ball milling, roll milling, milling in vertical attritors, sand milling, and the like. Exemplary milling times using a ball roll mill are from about 4 to about 6 days.

Charge transport materials include an organic polymer or non-polymeric material capable of supporting the injection of photoexcited holes or transporting electrons from the photoconductive material and allowing the transport of these holes or electrons through the organic layer to selectively dissipate a surface charge. Illustrative charge transport materials include for example a positive hole transporting material selected from compounds having in the main chain or the side chain a polycyclic aromatic ring such as anthracene, pyrene, phenanthrene, coronene, and the like, or a nitrogen-containing hetero ring such as indole, carbazole, oxazole, isoxazole, thiazole, imidazole, pyrazole, oxadiazole, pyrazoline, thiadiazole, triazole, and hydrazone compounds. Examples of hole transport materials include electron donor materials, such as carbazole; N-ethyl carbazole; N-isopropyl carbazole; N-phenyl carbazole; tetraphenylpyrene; 1-methyl pyrene; perylene; chrysene; anthracene; tetraphene; 2-phenyl naphthalene; azopyrene; 1-ethyl pyrene; acetyl pyrene; 2,-benzochrysene; 2,4-benzopyrene; 1,4-bromopyrene; poly(N-vinylcarbazole); poly(vinylpyrene); poly(vinyltetraphene); poly(vinyltetracene) and poly(vinylperylene). Suitable electron transport materials include electron acceptors such as 2,4,7-trinitro-9-fluorenone; 2,4,5,7-tetranitro-fluorenon; dinitroanthracene; dinitroacridene; tetracyanopyrene; dinitroanthraquinone; and butylcarbonylfluorenemalononitrile, reference U.S. Pat. No. 4,921,769. Other hole transporting materials include arylamines described in U.S. Pat. No. 4,265,990, such as N,N′-diphenyl-N,N′-bis(alkylphenyl)-(1,1′-biphenyl)-4,4′-diamine wherein alkyl is selected from the group consisting of methyl, ethyl, propyl, butyl, hexyl, and the like. Other known charge transport layer molecules can be selected, reference for example U.S. Pat. Nos. 4,921,773 and 4,464,450.

Any suitable inactive resin binder may be employed in the charge transport layer. Examples of inactive resin binders soluble in methylene chloride include polycarbonate resin, polyvinylcarbazole, polyester, polyarylate, polystyrene, polyacrylate, polyether, polysulfone, and the like. Molecular weights can vary from about 20,000 to about 1,500,000. In a charge transport layer, the weight ratio of the charge transport material (“CTM”) to the binder ranges from 30 (CTM):70 (binder) to 70 (CTM):30 (binder).

Any suitable technique may be utilized to apply the charge transport layer and the charge generating layer to the substrate. Examples of coating techniques, include dip coating, roll coating, spray coating, rotary atomizers, and the like. The coating techniques may use a wide concentration of solids. In one embodiment, the solids content is at least 2 percent by weight based on the total weight of the dispersion. In another embodiment, the solids content is no more than 30 percent by weight based on the total weight of the dispersion, although the amount can be outside of these ranges. The expression “solids” refers to the photoconductive pigment particles and binder components of the charge generating coating dispersion and to the charge transport particles and binder components of the charge transport coating dispersion. These solids concentrations are useful in dip coating, roll, spray coating, and the like. Generally, a more concentrated coating dispersion is used for roll coating. Drying of the deposited coating may be effected by any suitable conventional technique such as oven drying, infra-red radiation drying, air drying and the like. Generally, the thickness of the charge generating layer ranges. For example, in one embodiment, the thickness is at least 0.1 micrometer, and in another embodiment, no more than 3 micrometers, although the amount can be outside of these ranges. The thickness of the transport layer may be at least 5 micrometers in one embodiment, and no more than 100 micrometers in another embodiment, but thicknesses outside these ranges can also be used. In general, the ratio of the thickness of the charge transport layer to the charge generating layer is maintained from about 2:1 to 200:1 and in some instances as great as 400:1, although the amount can be outside of these ranges.

The materials and procedures described herein can be used to fabricate a single imaging layer type photoreceptor containing a binder, a charge generating material, and a charge transport material. For example, the solids content in the dispersion for the single imaging layer may range. For example, the solids content is at least 2% by weight, based on the weight of the dispersion, in one embodiment. In another embodiment, the solids content is no more than 30% by weight, based on the weight of the dispersion, although the amount can be outside of these ranges.

Where the imaging layer is a single layer combining the functions of the charge generating layer and the charge transport layer, illustrative amounts of the components contained therein are as follows: charge generating material (about 5% to about 40% by weight), charge transport material (about 20% to about 60% by weight), and binder (the balance of the imaging layer).

The Overcoating Layer

Present embodiments can, optionally, further include an overcoating layer or layers 8, which, if employed, are positioned over the charge generation layer or over the charge transport layer. This layer comprises organic polymers or inorganic polymers that are electrically insulating or slightly semi-conductive.

Such a protective overcoating layer includes a film forming resin binder optionally doped with a charge transport material. Any suitable film-forming inactive resin binder can be employed in the overcoating layer of the present embodiments. For example, the film forming binder can be any of a number of resins, such as polycarbonates, polyarylates, polystyrene, polysulfone, polyphenylene sulfide, polyetherimide, polyphenylene vinylene, and polyacrylate. The resin binder used in the overcoating layer can be the same or different from the resin binder used in the anti-curl layer or in any charge transport layer that may be present. The binder resin in specific embodiments has a Young's modulus greater than about 2×10⁵ psi, a break elongation no less than 10%, and a glass transition temperature greater than about 150 degrees C. The binder may further be a blend of binders. Some specific polymeric film forming binders include MAKROLON™, a polycarbonate resin having a weight average molecular weight of about 50,000 to about 100,000 available from Farbenfabriken Bayer A. G., 4,4′-cyclohexylidene diphenyl polycarbonate, available from Mitsubishi Chemicals, high molecular weight LEXAN™ 135, available from the General Electric Company, ARDEL™ polyarylate D-100, available from Union Carbide, and polymer blends of MAKROLON™ and the copolyester VITEL™ PE-100 or VITEL™ PE-200, available from Goodyear Tire and Rubber Co.

In embodiments, at least 1% by weight of the overcoating layer of VITEL™ copolymer is used in blending compositions. In one embodiment, no more than about 10% by weight of the overcoating layer of VITEL™ copolymer is used in blending compositions. In specific embodiments, at least 3% by weight is used in one embodiment and no more than 7% by weight is used in another embodiment, although the amount can be outside of these ranges. Other polymers that can be used as resins in the overcoat layer include DUREL™ polyarylate from Celanese, polycarbonate copolymers LEXAN™ 3250, LEXAN™ PPC 4501, and LEXAN™ PPC 4701 from the General Electric Company, and CALIBRE™ from Dow.

Additives may be present in the overcoating layer. In one embodiment the additive is present by at least 0.5 weight percent of the overcoating layer. In another, the additive is present by no more than 40 weight percent of the overcoating layer, although the amount can be outside of these ranges. Examples of additives include organic and inorganic particles which can further improve the wear resistance and/or provide charge relaxation property. Examples of organic particles include Teflon powder, carbon black, and graphite particles. Examples of inorganic particles include insulating and semiconducting metal oxide particles such as silica, zinc oxide, tin oxide and the like. Another semiconducting additive is the oxidized oligomer salts as described in U.S. Pat. No. 5,853,906. The oligomer salts are oxidized N,N,N′,N′-tetra-p-tolyl-4,4′-biphenyldiamine salt.

The overcoating layer can be prepared by any suitable conventional technique and applied by any of a number of application methods. Examples of application methods include, for example, hand coating, spray coating, web coating, dip coating and the like. Drying of the deposited coating can be effected by any suitable conventional techniques, such as oven drying, infrared radiation drying, air drying, and the like.

Overcoatings of from about 3 micrometers to about 7 micrometers are effective in preventing charge transport molecule leaching, crystallization, and charge transport layer cracking. In one specific embodiment, a layer having a thickness of from about 3 micrometers to about 5 micrometers is employed, although the amount can be outside of these ranges.

The Ground Strip

Ground strip 9 can comprise a film-forming binder and electrically conductive particles. Cellulose may be used to disperse the conductive particles. Any suitable electrically conductive particles can be used in the electrically conductive ground strip layer 9. The ground strip 9 can, for example, comprise materials that include those enumerated in U.S. Pat. No. 4,664,995. Examples of electrically conductive particles include, but are not limited to, carbon black, graphite, copper, silver, gold, nickel, tantalum, chromium, zirconium, vanadium, niobium, indium tin oxide, and the like.

The electrically conductive particles can have any suitable shape. Examples of shapes include irregular, granular, spherical, elliptical, cubic, flake, filament, and the like. In one embodiment, the electrically conductive particles have a particle size less than the thickness of the electrically conductive ground strip layer to avoid an electrically conductive ground strip layer having an excessively irregular outer surface. An average particle size of less than about 10 micrometers generally avoids excessive protrusion of the electrically conductive particles at the outer surface of the dried ground strip layer and ensures relatively uniform dispersion of the particles through the matrix of the dried ground strip layer. Concentration of the conductive particles to be used in the ground strip depends on factors such as the conductivity of the specific conductive materials utilized.

In embodiments, the ground strip layer may have a thickness of from about 7 micrometers to about 42 micrometers and, in one specific embodiment, from about 14 micrometers to about 27 micrometers, although the amount can be outside of these ranges.

Various exemplary embodiments encompassed herein include a method of imaging which includes generating an electrostatic latent image on an imaging member, developing a latent image, and transferring the developed electrostatic image to a suitable substrate.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below and is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

An undercoat dispersion comprising titanium oxide, phenolic resin, organic solvent was prepared via the standard manufacturing procedure used. The standard manufacturing procedure consists of a milling process of the above components with zirconium beads in a Dynomill® KDL-Pilot milling apparatus. A sample of the dispersion was taken from a standard batch and separated into three equal portions into 120-ml amber bottles. One portion of the dispersion was set aside as a control and had no changes. The two other samples received different amounts of TOSPEARL™ 145 so as to have percentages of TOSPEARL™ of 1.65% and 3.3% by weight to the solid concentrations. The TOSPEARL 145 is a silicon resin sphere chemically known as Polymethylsesquioxane (also Polymethylsilsesquioxane). It is a white powder made from 100% polymethylsesquioxane with an average particle size of 4 μm.

Once the proper amounts of TOSPEARL™ 145 were weighed out, they were added to the respective portion of the undercoat dispersion. The TOSPEARL™ 145 was slowly and carefully added to the dispersion. Once the TOSPEARL™ was added, the entire dispersion was placed in a sonication bath for 30 minutes. The sonication was necessary to break up any TOSPEARL™ agglomerates that might have formed during addition. Next, the dispersions were removed from the sonication bath and placed on a roller. The dispersions were allowed to roll for 16 hours (overnight) prior to coating.

Photoreceptor devices were fabricated and used in a test fixture for 40 mm diameter devices on mirror lathed aluminum substrates. All three dispersions were coated to the same thickness, 10 μm. The subsequent charge generation layer (CGL) applied was standard chlorogallium phthalocyanine in a binder solution. The charge transport layer (CTL) applied was PTFE Mod11K1 (available from Xerox Corporation) with charge transport molecules in a binder solution coated to 32 μm (standard thickness). Another set of photoreceptor devices were fabricated with the CTL coated to a thickness of 20 μm to simulate an end of life sample. All samples were submitted for electrical scanning and print testing.

### EXAMPLE 1

Photoreceptors Having 32 μm CTL Thickness

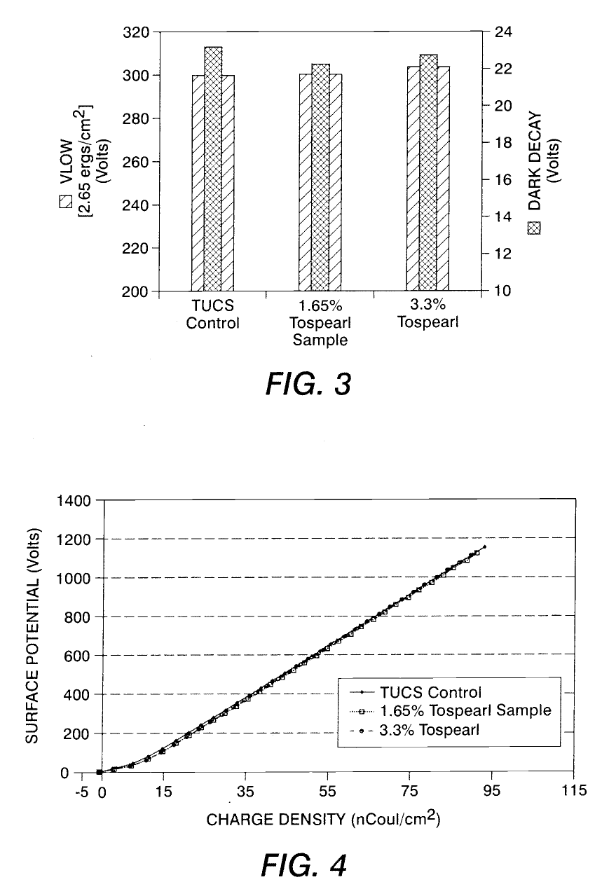

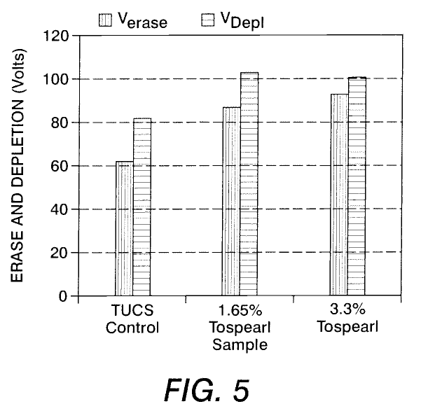

The samples coated to 32 μm CTL thickness had very good electrical characteristics. The electrical characteristics were obtained from a proprietary fixture which can hold the 40 mm diameter photoreceptor device, charge the photoreceptor uniformly, and discharge the photoreceptor with a laser of 780 nm light. Included in the fixture are various probes measuring surface potential at different time and space intervals. The data from these probes are used to electrically characterize the photoreceptor device tested. The photoreceptor device was print tested with a DOCUCOLOR 240/250 series printer offered by Xerox Corporation. The experimental devices containing TOSPEARL™ 145 were very close to the control with respect to V_{low} at 2.65 ergs/cm², dark decay, and charge acceptance. The comparisons for V_{low} and dark decay are shown in FIG. 3. The control and the 1.65% TOSPEARL™ sample had the same V_{low} value of 300 volts. The 3.3% TOSPEARL™ sample had a V_{low} value of 304 volts which is within the 5 volts noise error of the scanner. Dark decay also showed almost no change with values of 23 volts, 22 volts, and 23 volts for the control, 1.65% TOSPEARL, and 3.3% TOSPEARL, respectively. The charge acceptance curves are shown in FIG. 4. All three curves overlay almost perfectly straight to show good charge acceptance for all of the devices.

Prior to print testing, all the samples were observed under a sodium lamp. The sodium lamp can bring out the interference plywood defect pattern on the surface of the photoreceptor device. Under the sodium lamp a plywood defect pattern was only observed on the control. No defect pattern was seen on either of the TOSPEARL™ samples.

Time zero print tests showed no plywood for any of the samples. This is not surprising because of the 32 μm PTFE CTL. The thick PTFE layer can “hide” the plywood defect at time zero. Also important to note is that there was no ghosting or background observed in the prints. So at time zero the TOSPEARL™ does not seem to do anything for plywood print defect that is not there, but it does not cause any other print defects. For this reason samples were coated with a 20 μm CTL. The 20 μm samples were also submitted for electrical scanning and print testing.

### EXAMPLE 2

Photoreceptors Having 20 μm CTL Thickness

Once again, the samples had very good electrical characteristics when compared to the control. The V_{low}, Dark Decay, and charge acceptance were very close between the TUC6 control and the samples containing TOSPEARL™. Also the differences in Vₑᵣₐₛₑ and V_{depletion} were less than in the 32 μm samples. V_{low} increased with TOSPEARL™ concentration, but only slightly. The control, 1.65% TOSPEARL, and 3.3% TOSPEARL™ had V_{low} values of 351 volts, 354 volts, and 360 volts, respectively. In the case of dark decay, the values were 18 volts, 20 volts, and 19 volts for the control, 1.65% TOSPEARL, 3.3% TOSPEARL, respectively. Good charge acceptance was demonstrated with all three samples exhibiting almost identical straight line behavior.

The control and the TOSPEARL™ samples still showed some differences in Vₑᵣₐₛₑ and V_{depletion}, but not as drastic as the samples in the 32 μm thick CTL study. As expected from the 32 μm CTL study, the Vₑᵣₐₛₑ increased for samples with TOSPEARL™. The control had a Vₑᵣₐₛₑ of 44 volts while the 1.65% TOSPEARL™ had 51 volts and 3.3% TOSPEARL™ had 49 volts. These are values that can be argued to be within the scanner noise. V_{depletion}, however, decreased in the samples with TOSPEARL, but not by much. The control had a V_{depletion} of 67 volts. The 1.65% TOSPEARL™ had 65 volts and the 3.3% TOSPEARL™ had 57 volts. These were very modest decreases.

Again, all samples were observed under a sodium lamp before print testing. As before the control device showed very clear plywood pattern and the 3.3% TOSPEARL™ sample showed no plywood defect. However, the 1.65% TOSPEARL™ sample showed a slight plywood pattern.

Time zero and time 500 prints were run for the print test. Slight plywood patterns were observed in the control prints. No plywood was observed in the samples containing TOSPEARL™. These visual results were verified by another independent observer as well. Just as before, there was no ghosting or background observed in any of the samples. As a result, it was demonstrated that the TOSPEARL™ unexpectedly suppressed the plywood without compromising any other critical print characteristics.

All the patents and applications referred to herein are hereby specifically, and totally incorporated herein by reference in their entirety in the instant specification.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An imaging member, comprising:
a substrate;
an undercoat layer disposed on the substrate; and
an imaging layer disposed on the undercoat layer, wherein the undercoat layer is formed from an undercoat layer dispersion comprising silica microspheres with light scatter sufficient to change a refractive index of the undercoat layer dispersion and substantially eliminate plywood print defect in prints using the imaging member, a binder resin and a solvent.

2. The imaging member of claim 1 having substantially the same electrical properties as those of an imaging member having an undercoat layer formed from an undercoat layer dispersion not comprising the silica microspheres.

3. The imaging member of claim 1, wherein the undercoat layer dispersion further includes a metal oxide.

4. The imaging member of claim 3, wherein the metal oxide is selected from the group consisting of titanium oxide, zinc oxide, metal flakes, and mixtures thereof.

5. The imaging member of claim 1, wherein the silica microspheres are selected from the group consisting of methylsesquioxane (methylsilsesquioxane), and mixtures thereof.

6. The imaging member of claim 1, wherein the binder resin is selected from the group consisting of phenolic resin, polyvinyl butyral, epoxy resins, polyesters, polysiloxanes, polyurethanes, polyamides, and mixtures thereof.

7. The imaging member of claim 1, wherein the solvent is an organic solvent.

8. The imaging member of claim 1, wherein the substrate comprises aluminum, titanium, nickel, stainless steel, chromium, tungsten, copper, and mixtures thereof.

9. The imaging member of claim 1, wherein the silica microspheres have a particle size of from about 1 μm to about 7 μm in diameter.

10. The imaging member of claim 1, wherein the silica microspheres are present in the undercoat layer dispersion in an amount of from about 1% to about 4% by weight of the solid concentrations.

11. The imaging member of claim 10, wherein the silica microspheres are present in the undercoat layer dispersion in an amount of from about 1.65% to about 3.3% by weight of the solid concentrations.

12. The imaging member of claim 1, wherein the silica microspheres to binder resin ratio is from about 1 (microspheres)/40 (binder resin) to 10 (microspheres)/40 (binder resin).

13. An imaging member, comprising:
an aluminum substrate;
an undercoat layer disposed on the substrate; and
an imaging layer disposed on the undercoat layer, wherein the undercoat layer is formed from an undercoat layer dispersion comprising methylsesquioxane microspheres, titanium oxide, a phenolic binder resin and an organic solvent.

14. The imaging member of claim 13, wherein the methylsesquioxane microspheres have a particle size of from about 1 μm to about 7 μm in diameter.

15. The imaging member of claim 13, wherein the methylsesquioxane microspheres are present in the undercoat layer dispersion in an amount of from about 1% to about 4% by weight of the solid concentrations.

16. The imaging member of claim 15, wherein the methylsesquioxane microspheres are present in the undercoat layer dispersion in an amount of from about 1.65% to about 3.3% by weight of the solid concentrations.

17. A method for making an imaging member exhibiting substantially reduced levels of plywood print defect, comprising:
providing a substrate;
dispersing methylsesquioxane microspheres and a binder resin in a solvent to form an undercoat layer dispersion;
using the undercoat layer dispersion to form an undercoat layer on the substrate; and
forming an imaging layer on the undercoat layer.

18. The method of claim 17, wherein the methylsesquioxane microspheres have a particle size of from about 1 μm to about 7 μm in diameter.

19. The method of claim 17, wherein the methylsesquioxane microspheres are present in the undercoat layer dispersion in an amount of from about 1% to about 4% by weight of the solid concentrations.

20. The method of claim 19, wherein the methylsesquioxane microspheres are present in the undercoat layer dispersion in an amount of from about 1.65% to about 3.3% by weight of the solid concentrations.

21. The imaging member of claim 17, wherein the methylsesquioxane microspheres to binder resin ratio is from about 1 (microspheres)/40 (binder resin) to 10 (microspheres)/40 (binder resin).
